(19) United States
(12) Patent Application Publication
(10) Pub. No.: US 2003/0006135 A1
(43) Pub. Date: Jan. 9, 2003

(54) Plating apparatus and plating method, and method of manufacturing semiconductor device

(75) Inventor: Cozy Ban, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Tokyo (JP)

(21) Appl. No.: 10/105,297

(22) Filed: Mar. 26, 2002

(30) Foreign Application Priority Data
Jul. 6, 2001 (JP) 2001-206084

(51) Int. Cl. C25B 9/00; C25B 15/00; C25C 7/00; C25D 17/00; C25F 7/00; B23H 11/00

(52) U.S. Cl. 204/274; 204/275.1; 204/276; 204/278

(57) ABSTRACT

The plating solution held in tanks (1, 2) alternatively circulates a plating chamber (20) by the operations of valves (21 to 24). In the circulating tank (1 or 2) in suspension, a TOCUV lamp (11 or 12) lights up. Material inhibiting the plating processing, which is organic matter generated by decomposition of additives during the plating processing, is decomposed to be harmless by TOCUV. Deficient additives are replenished from a component adjuster (33) to the circulating tank (1 or 2) in suspension. Thus, using a plating solution of which components are adjusted properly, plating processing can be performed continuously without dumping the plating solution.

### BACKGROUND OF THE INVENTION

1. Field of the Invention

The present invention relates to a plating apparatus, a plating method, and a method of manufacturing a semiconductor device. The invention particularly relates to improvements in performing plating processing using a high-quality plating solution without interruption.

2. Description of the Background Art

As is known in the art, it is essential to the step of forming wiring and the like on a semiconductor substrate by employing plating processing that the concentrations of components in a plating solution be maintained constant. For the purpose of this, the following method is conventionally known. That is, a prepared plating solution is applied to the processing and the plating solution is replaced by a newly prepared plating solution when the deterioration of the processing quality is found, or after an elapse of the lifetime based on experience. There has also been employed, as the case may be, the method of using a plating solution for a long period of time by periodically replenishing the main components of the plating solution in the required amounts such that their respective concentrations are maintained constant.

In the case of, for example, copper plating, the main components of a plating solution therefor are inorganic components such as Cu (copper) ion, sulfuric acid and hydrochloric acid, and additive components such as brightener and carrier. Since the conventional use of plating had a large margin for variations of these components, a sufficient performance was obtainable with the mentioned solution control technique.

However, a higher filling performance is required for manufacturing advanced devices of which design rule is not more than 0.25 μm. For instance, it is necessary to reliably fill a via hole having a width of 0.25 μm and an aspect ratio of 4. Since it is difficult for the mentioned solution control technique to control the respective components under strict specification, a certain component is easy to depart from the specification. To avoid this, frequent exchange of the solution is needed, which involves high manufacturing cost, thus making it difficult to make a profit.

The investigations of the present inventor have led to the discovery that in strict-size patterns, filling performance is unstable even under such a control that the main components fall within control range by the addition of the respective components. The inventor further investigated the cause for this and has found that by-product generated by decomposition of the conventionally controlled additive components, accumulates in a plating solution, and suppresses or accelerates the effects of the additives, thus hindering the stability of filling performance.

To the advanced semiconductor manufacture processing for which high filling performance is required, it is essential to strictly control the by-product concentration. The detecting peak of the by-product overlaps the peak of the additives themselves and its peak is low. At present, however, there is no technique of conducting its quantitative measurement on online, and there is no means other than that the accumulated by-product is controlled at low concentrations based on the data measured on offline. It is therefore unavoidable to frequently dump plating solutions. However, a frequent discharge of plating solutions raises cost and is also impractical from the interest of environment. The reason for this is as follows. In Japan, article 3 of Prevention of Water Pollution Act and article 12 of Sewerage Water Law call for not more than 3 ppm in the emission concentration of Cu ions. Therefore, a dilution with a large amount of water or a special treatment is necessary for dumping Cu ions of several tens g/L (“L” indicates liter), which is generally used.

Thus, with existing techniques, some problems occur from the point of view of plating performance, cost and environment. It is therefore impossible to achieve control of the main components of a plating solution at accuracy suitable for the advanced device manufacture. In addition, the downtime of processing apparatuses due to the exchange of plating solutions is an industrial problem.

### SUMMARY OF THE INVENTION

It is an object of the present invention to overcome the foregoing problems in the conventional techniques by providing a plating apparatus, a plating method, and a method of manufacturing a semiconductor device employing the apparatus and the method, which are capable of achieving control of the main components of a plating solution at accuracy suitable for advanced device manufacture, without causing any problems in the interests of plating performance, cost, and environment.

According to a first aspect of the invention, a plating apparatus comprises: (i) a plating chamber for holding a plating solution and performing plating processing of a processing object to be immersed in the plating solution; (ii) plural circulating tanks, each having an organic matter decomposing means for decomposing organic matter contained in the plating solution; (iii) a first valve freely selecting one of the plural circulating tanks to provide communication between the selected one and the plating chamber such that the plating solution can circulate therebetween; and (iv) a pump to circulate the plating solution between the selected one of the plural circulating tanks and the plating chamber.

According to a second aspect of the invention, the plating apparatus of the first aspect further comprises: a component adjuster to replenish components of the plating solution; and a second valve freely selecting one of the plural circulating tanks to provide communication between the selected one and the component adjuster.

According to a third aspect of the invention, the plating apparatus of the second aspect further comprises: a component analyzer to analyze components of the plating solution; and a third valve freely selecting one of the plural circulating tanks to provide communication between the selected one and the component analyzer.

According to a fourth aspect of the invention, the plating apparatus of the third aspect further comprises a controller to control the first, second and third valves, the organic matter decomposing means and the component adjuster, the controller having the following functions of: (i) successively switching the first valve so as to select one of the plural circulating tanks every time the plating processing reaches a predetermined amount; (ii) with respect to the other of the plural circulating tanks, activating the organic matter decomposing means until the result of analysis of the component analyzer shows that the concentration of the organic matter reaches a permissible range; and (iii) with respect to the other of the plural circulating tanks, activating the component adjuster until the result of analysis of the component analyzer shows that the concentrations of components of the plating solution reach a permissible range.

According to a fifth aspect of the invention, a plating apparatus comprises: (i) a plating chamber to hold a plating solution and to perform plating processing of a processing object to be immersed in the plating solution; (ii) two circulating tanks, one of which has an organic matter decomposing means for decomposing organic matter contained in the plating solution, each of the two circulating tanks being communicated to the plating chamber so as to circulate the plating solution between each tank and the plating chamber; and (iii) a pump to circulate the plating solution between the two circulating tanks and the plating chamber.

According to a sixth aspect of the invention, the plating apparatus of the fifth aspect further comprises a component adjuster to replenish the plating solution in circulation with components of the plating solution.

According to a seventh aspect of the invention, the plating apparatus of the sixth aspect further comprises a component analyzer to analyze components of the plating solution in circulation.

According to an eighth aspect of the invention, the plating apparatus of the seventh aspect further comprises a controller for controlling the organic matter decomposing means and the component adjuster, the controller to control the component adjuster such that the result of analysis of the component analyzer shows that the concentrations of components of the plating solution are in a permissible range.

According to a ninth aspect of the invention, the plating apparatus of one of the fifth to seventh aspects further comprises a controller to control the organic matter decomposing means, the controller activating the organic matter decomposing means only when the plating chamber performs the plating processing of the processing object.

According to a tenth aspect of the invention, a plating apparatus comprises: (i) a plating chamber to hold a plating solution and to perform plating processing of a processing object to be immersed in the plating solution; (ii) a circulating tank communicated to the plating chamber so as to circulate the plating solution between the circulating tank and the plating chamber; and (iii) a buffer tank having an organic matter decomposing means for decomposing organic matter contained in the plating solution, the buffer tank being communicated to the circulating tank so as to circulate the plating solution between the buffer tank and the circulating tank; (iv) a first pump to circulate the plating solution between the circulating tank and the plating chamber; and (v) a second pump to circulate the plating solution between the buffer tank and the circulating tank.

According to an eleventh aspect of the invention, the plating apparatus of the tenth aspect further comprises a component adjuster to replenish the plating solution circulating between the buffer tank and the circulating tank with components of the plating solution.

According to a twelfth aspect of the invention, the plating apparatus of one of the first to eleventh aspects is characterized in that the organic matter decomposing means has an ultraviolet lamp generating ultraviolet.

According to a thirteenth aspect of the invention, the plating apparatus of one of the first to eleventh aspects is characterized in that the organic matter decomposing means has a pair of electrodes electrolyzing the plating solution.

According to a fourteenth aspect of the invention, the plating apparatus of the thirteenth aspect is characterized in that a main component of at least one of the paired electrodes is the same as a main component of material to be plated to the processing object.

According to a fifteenth aspect of the invention, the plating apparatus of the fourteenth aspect is characterized in that a main component of each of the paired electrodes is the same as a main component of material to be plated to the processing object.

According to a sixteenth aspect of the invention, the plating apparatus of the fifteenth aspect further comprises a current supply means for supplying the paired electrodes with current of which polarity is changeable.

According to a seventeenth aspect of the invention, the plating apparatus of one of the first to sixteenth aspects further comprises a carbon dioxide removal film to remove carbon dioxide from the plating solution, the removal film being interposed on a circulating path of the plating solution.

According to an eighteenth aspect of the invention, a plating apparatus comprises: (i) a plating chamber to hold a plating solution and to perform plating processing of a processing object to be immersed in the plating solution; (ii) a circulating path communicated to the plating chamber so as to circulate the plating solution; (iii) a pump to circulate the plating solution, the pump being interposed on the circulating path; and (iv) a carbon dioxide removal film to remove carbon dioxide from the plating solution, the carbon dioxide removal film being interposed on a circulating path of the plating solution.

According to a nineteenth aspect of the invention, a plating method comprises the steps of: (a) preparing a plating apparatus of the first aspect; (b) preparing the processing object; (c) performing the plating processing of the processing object by using the plating apparatus, the step (c) including the steps of: (c-1) successively switching the first valve so as to select one of the plural circulating tanks every time the plating processing reaches a predetermined amount; (c-2) with respect to the other of the plural circulating tanks, activating the organic matter decomposing means until the organic matter concentration reaches a permissible range; and (c-3) with respect to the other of the plural circulating tanks, replenishing components of the plating solution until their respective concentrations reach a permissible range.

According to a twentieth aspect of the invention, a plating method comprises the steps of: (a) preparing a plating apparatus of the fifth aspect; (b) preparing the processing object; (c) performing the plating processing of the processing object by using the plating apparatus, the step (c) including the step of: (c-1) replenishing the components of the plating solution in circulation such that their respective concentrations are in a permissible range.

According to a twenty-first aspect of the invention, a plating method comprises the steps of: (a) preparing a plating apparatus of the tenth aspect; (b) preparing the processing object; (c) performing the plating processing of the processing object by using the plating apparatus, the step (c) including the steps of: (c-1) circulating the plating solution between the circulating tank and the plating chamber; (c-2) in parallel with the step (c-1), activating the organic matter decomposing means; and (c-3) in parallel with the step (c-1), replenishing the plating solution circulating between the buffer tank and the circulating tank with the components of the plating solution.

According to a twenty-second aspect of the invention, a plating method comprises the steps of: (a) preparing a plating apparatus of the fourteenth aspect; (b) preparing the processing object; (c) performing the plating processing of the processing object by using the plating apparatus; and (d) repetitively changing the polarity of current supplied to the paired electrodes.

According to a twenty-third aspect of the invention, a method of manufacturing a semiconductor device comprising the steps of: (a) preparing a plating apparatus of one of the first to eighteenth aspects; (b) preparing a semiconductor substrate as a processing object; and (c) plating a material of a semiconductor device to the semiconductor substrate by using the plating apparatus.

According to a twenty-fourth aspect of the invention, a method of manufacturing a semiconductor device wherein with a plating method of one of the nineteenth to twenty-second aspects, a material of a semiconductor device is plated to a semiconductor substrate as the processing object.

In the apparatus of the first aspect, the plural circulating tanks, each having an organic matter decomposing unit, are communicated to the plating chamber so as to be freely selected and circulate the plating solution. Therefore, by successively switching the circulating tank to be communicated to the plating chamber, and activating the organic matter decomposing unit of the circulating tank not in communication with the plating chamber, the plating processing of the processing object can be executed at the plating chamber using a plating solution having a low concentration of organic matter inhibiting the plating processing, without interruption and dump of the plating solution.

In the apparatus of the second aspect, the presence of the component adjuster and second valve enable to supply components to the plating solution of the circulating tank not in communication with the plating chamber, until the components have the moderate concentrations. Thereby, the plating chamber can execute plating processing of the processing object, without interruption, by using the plating solution in which the component concentrations are adjusted properly.

In the apparatus of the third aspect, the presence of the component analyzer and third valve enable to analyze the components of the plating solution of the circulating tank not in communication with the plating chamber. Therefore, the component concentrations can be adjusted at high accuracy and with ease, based on the result of analysis.

In the apparatus of the fourth aspect, the presence of the controller enables to automatically perform the change of circulating tanks to be communicated to the plating chamber, the decomposition of organic matters, and the adjustment of the components of the plating solution.

In the apparatus of the fifth aspect, the two circulating tanks are communicated to the plating chamber so as to circulate the plating solution, and the organic matter decomposing unit is disposed in one of the two circulating tanks. Therefore, by activating the organic matter decomposing unit and circulating the plating solution between the two circulating tanks and the plating chamber, the plating chamber can execute plating processing of the processing object by using a plating solution having a low concentration of organic matter inhibiting the plating processing, without interruption and dump of the plating solution.

In the apparatus of the sixth aspect, the presence of the component adjuster enables to replenish components such that their respective concentrations in the circulating plating solution are maintained in a proper range. Thereby, the plating chamber can execute plating processing of the processing object without interruption, by using a plating solution in which the component concentrations are adjusted properly.

In the apparatus of the seventh aspect, the presence of the component analyzer enables to adjust the concentrations of the components easily and at high accuracy, based on the result of analysis.

In the apparatus of the eighth aspect, the presence of the controller enables to automatically decompose organic matter and adjust the components of the plating solution.

In the apparatus of the ninth aspect, the presence of the controller enables to automatically decompose organic matter when necessary. That is, the organic matter can be decomposed effectively without manual operation.

In the apparatus of the tenth aspect, the buffer tank having the organic matter decomposing unit is communicated to the circulating tank. Therefore, by activating the organic matter decomposing unit while circulating the plating solution between the circulating tank and plating chamber, and between the buffer tank and circulating tank, the plating chamber can execute plating processing of the processing object with the plating solution having a low concentration of organic matter inhibiting the plating processing, without interruption and dump of the plating solution. Further, when a semiconductor is subjected to plating processing, the buffer tank can be placed in the exterior of a clean area, thereby reducing the area of the clean area that is high in maintenance cost.

In the apparatus of the eleventh aspect, the presence of the component adjuster enables to replenish the circulating plating solution with components such that their respective concentrations are maintained in a proper range. Thereby, the plating chamber can execute plating processing of the processing object, without interruption, by using a plating solution in which the component concentrations are adjusted properly.

In the apparatus of the twelfth aspect, the presence of the ultra violet lamp in the organic matter decomposing unit enables to effectively decompose organic matter. This facilitates handling and lowers the cost of the apparatus.

In the apparatus of the thirteenth aspect, the presence of the paired electrodes for electrolysis in the organic matter decomposing unit enables to effectively decompose organic matter. This facilitates handling and lowers the cost of the apparatus.

In the apparatus of the fourteenth aspect, a main component of at least one of the paired electrodes is the same as a main component of material to be plated. Therefore, using one of the electrodes as anode compensates for a reduction of the main component during plating processing.

In the apparatus of the fifteenth aspect, a main component of both of the paired electrodes is the same as a main component of material to be plated. Therefore, exhaustion of the paired electrodes can be suppressed by repetitively changing the polarity of current supplied to the paired electrodes, or by repetitively alternating the paired electrodes with each other.

In the apparatus of the sixteenth aspect, the presence of the current supply means enables that exhaustion of the paired electrodes can be suppressed by repetitively changing the polarity of current supplied to the paired electrodes.

In the apparatus of the seventeenth aspect, the presence of the carbon dioxide removal film enables to effectively remove the carbon dioxide generated as organic matter decomposes, as well as the carbon dioxide generated as the plating processing proceeds.

In the apparatus of the eighteenth aspect, by the presence of the carbon dioxide removal film, the carbon dioxide generated as the plating processing proceeds at the plating chamber can be removed effectively without interruption of the plating processing and dump of the plating solution.

In the method of the nineteenth aspect, the plating processing of the processing object is performed using the plating apparatus of the first aspect. Further, the first valve and organic matter decomposing unit are operated through a predetermined procedure, and replenishment of the components of the plating solution is also performed through a predetermined procedure. Therefore, the plating processing can be executed using a plating solution in which the concentration of organic matter inhibiting the plating processing is low and the component concentrations are adjusted properly, without interruption and dump of the plating solution.

In the method of the twentieth aspect, the plating processing of the processing object is performed using the plating apparatus of the fifth aspect. Further, the organic matter decomposing unit is operated through a predetermined procedure, and replenishment of the components of the plating solution is also performed through a predetermined procedure. Therefore, the plating processing can be executed using a plating solution in which the concentration of organic matter inhibiting the plating processing is low and the component concentrations are adjusted properly, without interruption and dump of the plating solution.

In the method of the twenty-first aspect, the plating processing of the processing object is performed using the plating apparatus of the tenth aspect. Further, the organic matter decomposing unit is operated through a predetermined procedure, and replenishment of the components of the plating solution is also performed through a predetermined procedure. Therefore, the plating processing can be executed using a plating solution in which the concentration of organic matter inhibiting the plating processing is low and the component concentrations are adjusted properly, without interruption and dump of the plating solution.

In the method of the twenty-second aspect, the plating processing of the processing object is performed using the plating apparatus of the fourteenth aspect. Repetitive change of current supplied to the paired electrodes suppresses exhaustion of the paired electrodes.

In the manufacturing method of the twenty-third aspect, with the plating apparatus of the invention, advanced semiconductor devices of which design rule is strict can be manufactured at low cost without environmental loading.

In the manufacturing method of the twenty-fourth aspect, the use of the plating apparatus of the invention enables to manufacture advanced semiconductor devices of which design rule is strict, at low cost and without environmental loading.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of an apparatus according to a first preferred embodiment of the invention;

FIG. 2 is a flowchart illustrating the procedure of a plating method using the apparatus of FIG. 1;

FIG. 3 is a block diagram of an apparatus according to another exemplary of the first preferred embodiment;

FIG. 4 is a block diagram of an apparatus according to a second preferred embodiment;

FIG. 5 is a diagram illustrating the operation of the apparatus of FIG. 4;

FIG. 6 is a block diagram of an apparatus according to a third preferred embodiment;

FIG. 7 is a flowchart illustrating the procedure of a plating method using the apparatus of FIG. 6;

FIG. 8 is a block diagram of an apparatus according to a fourth preferred embodiment;

FIG. 9 is a flowchart illustrating the procedure of a plating method using the apparatus of FIG. 8; and

FIG. 10 is a block diagram of an apparatus according to a fifth preferred embodiment.

### DESCRIPTION OF THE PREFERRED EMBODIMENTS

As a plating apparatus according to a preferred embodiment of the invention, there are described ones that have for its processing object a semiconductor substrate (i.e., a semiconductor wafer) and are arranged as an apparatus for plating a material of a semiconductor device on the semiconductor substrate. There are described the cases that a plating material is copper (Cu) typical of the advanced semiconductor processing. These are, however, not intended to be limiting of the invention, but, on the contrary, the invention is applicable to apparatuses for plating materials other than copper, and to general apparatuses taking objects other than semiconductor substrates as an object of plating processing.

First Preferred Embodiment

Construction of Apparatus

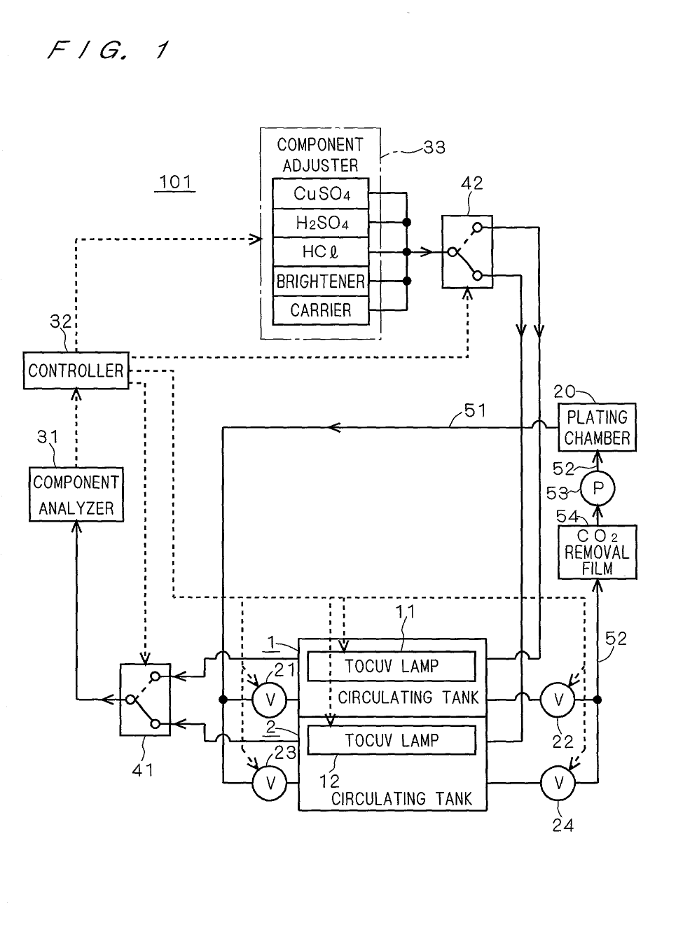

FIG. 1 is a block diagram illustrating the construction of a plating apparatus according to a first preferred embodiment of the invention. This plating apparatus 101 comprises two circulating tanks 1 and 2, plating chamber 20, valves 21 to 24, component analyzer 31, controller 32, component adjuster 33, valves 41 and 42, piping 51 and 52, pump 53, and carbon dioxide removal film 54. The circulating tanks 1 and 2 have TOCUV (total organic carbon ultra-violet) lamps 11 and 12, respectively.

The plating chamber 20 holds a plating solution and is an element of the apparatus that performs plating processing of a semiconductor substrate as a processing object to be immersed in the plating solution. The plating solution is also held in the circulating tanks 1, 2, and the piping 51, 52. The circulating tank 1 is connected to the plating chamber 20 via the valves 21, 22, and the piping 51, 52. Likewise, the circulating tank 2 is connected to the plating chamber 20 via the valves 23, 24, and the piping 51, 52. By opening one of the paired valves 21, 22 and the paired valves 23, 24, and closing the other, the circulating tank 1 or 2 is selected freely so that the selected tank is brought into communication with the plating chamber 20 so as to circulate the plating solution.

The TOCUV lamps 11 and 12 irradiate TOCUV, which are disposed for decomposing organic matter contained in the plating solution. UV (ultraviolet) generally means electromagnetic wave having a wavelength range of 1 to 400 nm. However, industrially usable ultraviolet lamps are limited, and lamps irradiating ultraviolet of which main peak of spectrum is a wavelength of 185 nm or 254 nm are generally used. Of these, ultraviolet of which main peak of spectrum is a wavelength of 185 nm has excellent characteristic of decomposing effectively almost every type of organic matter, and this ultraviolet is called TOCUV. Hence, the TOCUV lamp is especially suitable for use in the apparatus 101.

The pump 53 and carbon dioxide removal film 54 are interposed at any location on a circulating path through which the plating solution circulates between the circulating tanks 1, 2 and the plating chamber 20. In the case of FIG. 1, these are interposed on the piping 52. The pump 53 functions to circulate the plating solution. The carbon dioxide removal film 54 removes carbon dioxide (CO₂) contained in the circulating plating solution and it is formed by polypropylene, for example. Not only the piping 51 and 52, but the plating chamber 20 and circulating tanks 1 and 2 are also included in the circulating path. For instance, the pump 53 may be disposed on the piping 51, and the carbon dioxide removal film 54 may be disposed in the circulating tanks 1 and 2.

The component adjuster 33 is an element of replenishing the components of the plating solution, and is connected via the valve 42 to the circulating tanks 1 and 2. The component analyzer 31 is an element of analyzing the components of the plating solution, and is connected via the valve 41 to the circulating tanks 1 and 2. The valve 42 freely selects one of the circulating tanks 1 and 2, so that the selected one is brought into communication with the component adjuster 33. Likewise, the valve 41 freely selects one of the circulating tanks 1 and 2, so that the selected one is brought into communication with the component analyzer 31. The controller 32 controls the valves 21 to 24, 41 and 42, and also controls the TOCUV lamps 11 and 12 and the component adjuster 33, based on the result of analysis of the component analyzer 31.

Operation of Apparatus

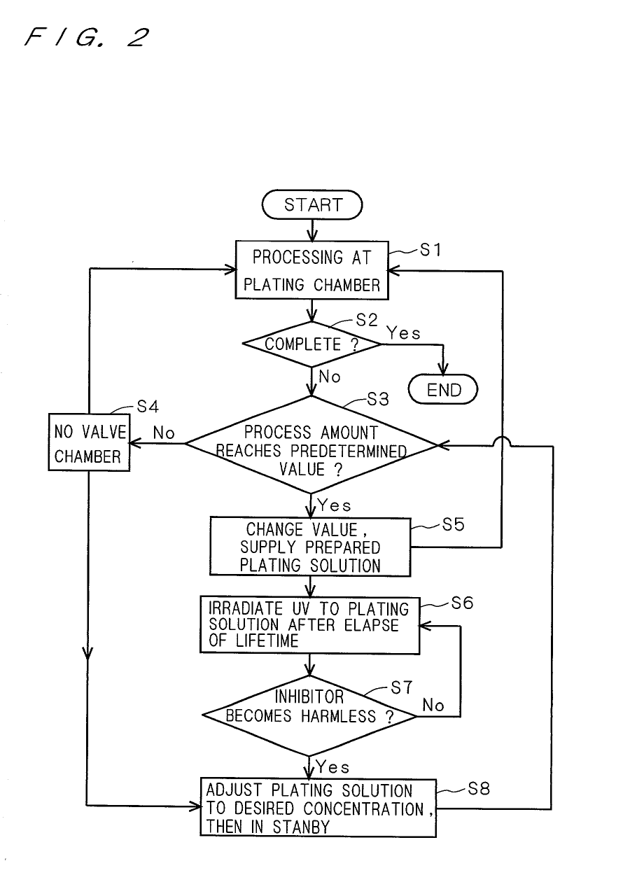

FIG. 2 is a flowchart illustrating the procedure of a plating method with which a semiconductor substrate is subjected to plating processing using the apparatus 101. Before starting the processing, a plating solution is prepared, and this plating solution is allowed to fill a circulating path of the plating solution, i.e., the plating chamber 20, piping 51, 52, and circulating tanks 1, 2. The plating solution is prepared by adjusting inorganic components such as Cu ion, H₂SO₄ and HCl, and organic components such as brightener (or accelerator) and carrier (or suppresser), to a predetermined concentration. The brightener (or accelerator) and carrier (or suppresser) belong to additives. Depending on the type of the additive and the pattern size of the semiconductor substrate, the concentrations of the respective components are set, for example, such that Cu ion is 17.5 g/L, Cl ion is 50 ppm, brightener is 1 mL/L, and carrier is 25 mL/L. In some cases, an organic component that is referred to as “leveler” is also added.

Upon completion of the above procedure, the pump 53 is operated to perform plating processing of a semiconductor substrate at the plating chamber 20 (step S1). Since the technique of plating processing itself is well known, its detail is omitted. At the beginning of plating processing, the TOCUV lamps 11 and 12 may be in off state. When the plating processing is started, for example, the valves 21 and 22 are opened and the valves 23 and 24 are closed. Thereby, the plating solution circulates between the plating chamber 20 and the circulating tank 1. Hereat, the plating processing is performed using the plating solution in the circulating tank 1.

Before staring the processing, data about the deterioration of organic components is taken in advance, to confirm throughput (e.g., a number of objects to be processed or processing time) to which filling performance or filming characteristic is maintained. Until throughput reaches the predetermined amount thus confirmed (step S3), the plating processing is repeated (steps S1, S4). When the throughput reaches the predetermined amount, the valves 21 and 22 are closed and the valves 23 and 24 are opened (step S5). As a result, the plating solution circulates between the plating chamber 20 and the circulating tank 2. Hereat, the plating processing is performed using a fresh plating solution held in the circulating tank 2 (step S1). Therefore, no halt of plating processing occurs, thus enabling to continue the plating processing in such a continuous fashion, in other words, free from downtime.

At the same time that the valve is changed, the TOCUV lamp 11 of the circulating tank 1 is arranged to light up (step S6). The deteriorated plating solution held in the circulating tank 1 in suspension usually contains sufficient inorganic components, and the concentrations of Cu ions, H₂SO₄ and Cl ions are often in the range of the usual specification, namely a permissible range. On the other hand, organic components decompose to form material having a smaller molecular weight, as a by-product. Specifically, by-product and additives coexist in the deteriorated plating solution. Therefore, only with adjustment of the concentrations of the additives by replenishing the deteriorated plating solution with the additives of the amount equivalent to decomposition, by-product may be gradually accumulated as the plating processing proceeds. As a result, the use of such a plating solution in manufacturing advanced devices might cause the deficiency of processing, such as failure of filling.

Whereas in the plating method using the apparatus 101, attention is given to the fact that by-product of additives serving as an inhibiting factor of the normal plating processing is a low molecular-weight material derived from the additives, and therefore, the by-product is decomposed by irradiation of TOCUV. As shown in the following chemical formula, the by-product is decomposed to yield CO₂ and H₂O. Thereby, the inhibitor is made harmless. The TOCUV lamp 11 is allowed to light up until the inhibitor becomes harmless (step S6, S7). The carbon dioxide removal film 54 is effective in removing CO₂ to be generated.

CₙH₂ₘO_{2n+m→n}CO₂+mH₂O

Subsequently, the deficient additives are added and, as required, inorganic components are adjusted, and the obtained plating solution is then placed in a standby condition until the plating solution of the circulating tank 2 that is being used for the processing becomes deteriorated (step S8). The plating solution in the circulating tank 1 may be prepared immediately before changing the circulating tank for plating processing due to the deterioration of the plating solution of the tank 2, that is, before changing from the tank 2 to the tank 1. The component adjuster 33 can be used for adjusting the plating solution. In this case, the valve 42 selects the circulating tank 1 to provide communication with the component adjuster 33. The plating solution can also be adjusted appropriately based on the result of analysis of the component analyzer 31. In this case, the valve 41 selects the circulating tank 1 to provide communication with the component analyzer 31. Control of the TOCUV lamp 11 (steps S6 and S7) can also be conducted appropriately based on the result of analysis of the component analyzer 31.

After starting the use of the plating solution in the circulating tank 2 (step S5), when throughput reaches the predetermined amount (step S3), the valves 21 and 22 are opened and the valves 23 and 24 are closed (step S5). As a result, the circulating tank 2 enters suspension, and the plating processing is performed using the prepared plating solution held in the circulating tank 1 (steps S5, S1). Then, the foregoing processing executed with the circulating tank 1 (steps S6 to S8) is done with the circulating tank 2. The mentioned sequence of processing is repeated until the time of completion (step S2).

Thus, with the plating method using the apparatus 101, the plating processing can be continued without causing any downtime. Additionally, the plating processing is executable using a plating solution in which the respective component concentrations are adjusted in a proper permissible range only by supplying the deficient additives, without dumping the plating solution. Therefore, advanced semiconductor devices of which design rule is strict can be manufactured at low cost. Further, it is unnecessary to dump the plating solution, thus involving no Cu ion discharge. This can relax environmental loading.

Other Exemplary of First Preferred Embodiment

In the apparatus 101, the controller 32 automatically executes the procedure in FIG. 2. That is, the judgment in step S3, the changes of the valves 21 to 24 (step S5), the control of the TOCUV lamps 11, 12 (steps S6, S7), and the controls of the valves 41, 42 and the component adjuster 33 to adjust the plating solution (step S8), are all executed based on the instruction of the controller 32.

As an alternative embodiment, the followings are feasible. Specifically, the controller 32 can be removed to perform the mentioned sequence of processing by hand. The component analyzer 31 can be removed to adjust the plating solution based on data confirmed in advance. The component adjuster 33 can be removed to replenish by hand the circulating tank 1 or 2, with a replenishment solution prepared in advance. However, it should be noted that the apparatus 101 including the controller 32 is superior to these embodiments in the efficiency and accuracy of processing.

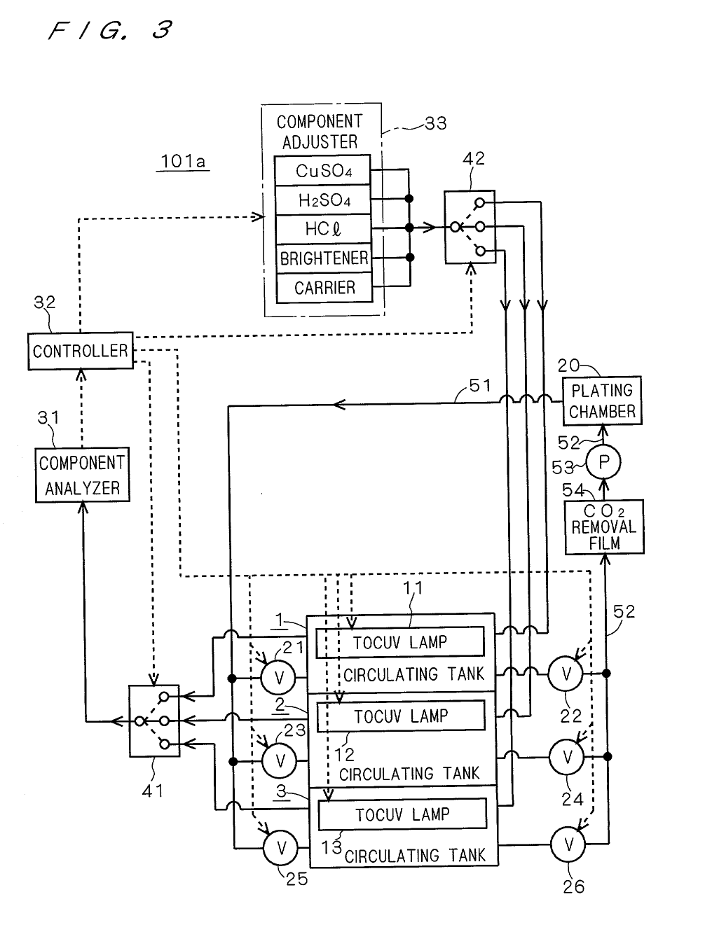

Alternatively, three or more circulating tanks can be used. FIG. 3 illustrates a plating apparatus 101a comprising three circulating tanks 1 to 3. The circulating tank 3 has a TOCUV lamp 13. Valves 25 and 26 are connected to the circulating tank 3. Valves 41 and 42 can freely select one of the three circulating tanks 1 to 3. Valves 21 to 26 select one of the circulating tanks 1 to 3 to make a communication with a plating chamber 20. The processing in steps S6 to S8 shown in FIG. 2 are performed with two tanks in suspension, among the tanks 1 to 3. For instance, the processing in steps S6 and S7 can be executed with one of the two circulating tanks in suspension, and the processing in step S8 with the other. The apparatus 101a is effective when the time required until throughput reaches a predetermined amount, namely when the switching cycle of the valves 21 to 26, is shorter than the time required for the processing in steps S6 to S8 with a single circulating tank.

Second Preferred Embodiment

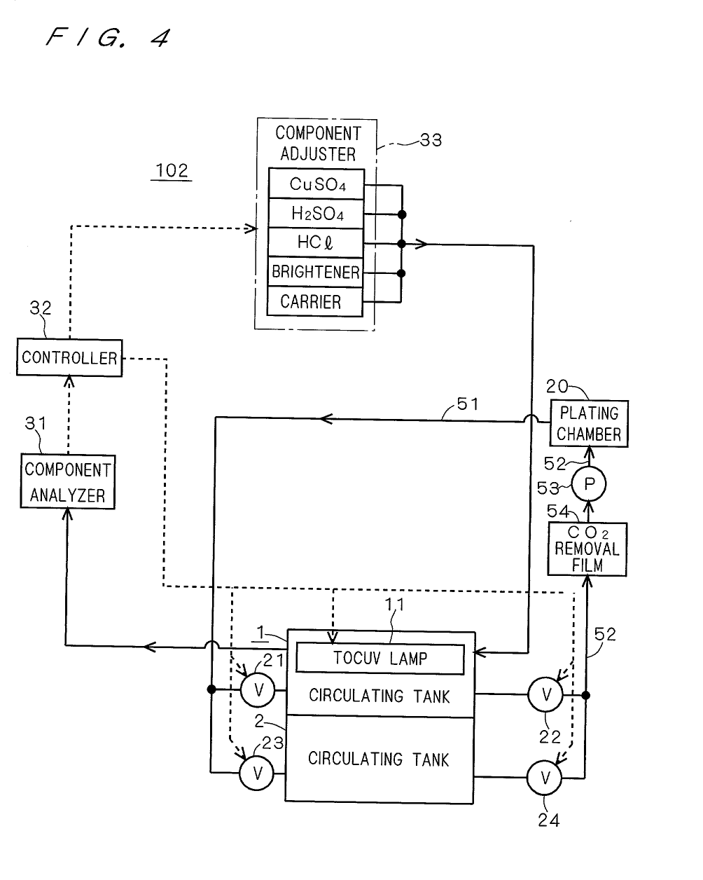

FIG. 4 is a block diagram illustrating the construction of a plating apparatus according to a second preferred embodiment. This plating apparatus 102 is characteristically different from the apparatus 101 in that a TOCUV lamp 11 is disposed only in one of two circulating tanks 1 and 2 (the circulating tank 1 in the exemplary of FIG. 4), and that a component adjuster 33 and component analyzer 31 are connected only to the one. The valves 41 and 42 (see FIG. 1) are removed.

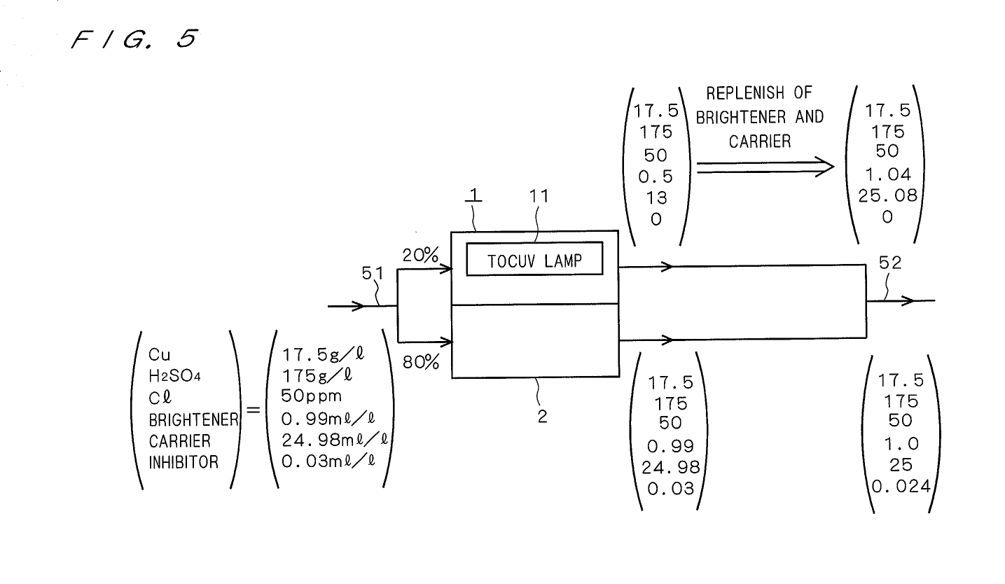

FIG. 5 is a diagram illustrating the operation of the apparatus 102. In the case of FIG. 5, a 20% of the plating solution passing through a plating chamber 20 runs in the circulating tank 1, and a 80% of which runs in the circulating tank 2. The valves 21 to 24 function to adjust the flow of the plating solution circulating the circulating tanks 1 and 2. The TOCUV lamp 11 may be arranged to light up all the time, preferably only the period that the plating chamber 20 performs the plating processing. Since a 20% of the circulating plating solution passes through the circulating tank 1, every time it passes through a circulating path, inhibitor contained in the plating solution is decreased by 20%.

The concentrations of the respective components contained in the plating solution passing from the plating chamber 20 to the circulating tanks 1 and 2 are, for example, as shown downward toward the left in FIG. 5. In this case, even if the plating solution passes through the circulating tank 2, the components of the plating solution remain unchanged. Whereas in the plating solution passed through the circulating tank 1, inhibitor is decomposed and its concentration is reduced to zero. Depending on the components of brightener and carrier, their respective concentrations are also lowered in some cases. FIG. 5 shows an example that the brightener concentration is reduced from 0.99 mL/L to 0.5 mL/L, and the carrier concentration is reduced from 24.98 mL/L to 13 mL/L.

The plating solutions passed through the two circulating tanks 1 and 2 are then combined. In order to correct deviations from the proper values of the concentrations of the respective components, brightener and carrier are supplied to the plating solution in the circulating tank 1. The replenishment amount is calculated based on the ratio of flow to the two circulating tanks 1 and 2. In the example of FIG. 5, a component adjustment is made such that brightener is 1.04 mL/L and carrier is 25.08 mL/L. As a result, the combined plating solution contains brightener in 1.0 mL/L and carrier in 25 mL/L. The inhibitor is contained in an amount of 0.024 mL/L. Other components of the plating solution remain unchanged before entering the circulating tanks 1 and 2, and after combining. In addition to the replenishment of brightener and carrier, inorganic components can be replenished if they vary.

Thus, every time the plating solution circulates, the inhibitor is decreased by 20%, and the plating solution in which the concentrations of the respective components are adjusted in an appropriate permissible range is always supplied to the plating chamber 20. That is, the plating processing can be executed continuously with the plating solution adjusted properly, without dumping the plating solution.

In the apparatus 102, the valves 21 to 24 regulating the flow ratio and the component adjuster 33 adjusting the plating solution are controlled automatically, based on the instruction of the controller 32. The controller 32 also allows the TOCUV lamp 11 to light up only for the period of plating processing. The component adjuster 33 is controlled properly based on the flow ratio and the result of analysis of the component analyzer 31. There are, for example, the following alternatives. The controller 32 can be removed to perform the mentioned sequence of processing by hand. The component analyzer 31 can be removed to adjust the plating solution based on the data confirmed in advance. The component adjuster 33 can be removed to replenish, by hand, the circulating tank 1 with a replenishment solution prepared in advance. The valves 21 to 24 can be removed to fix the flow ratio.

Third Preferred Embodiment

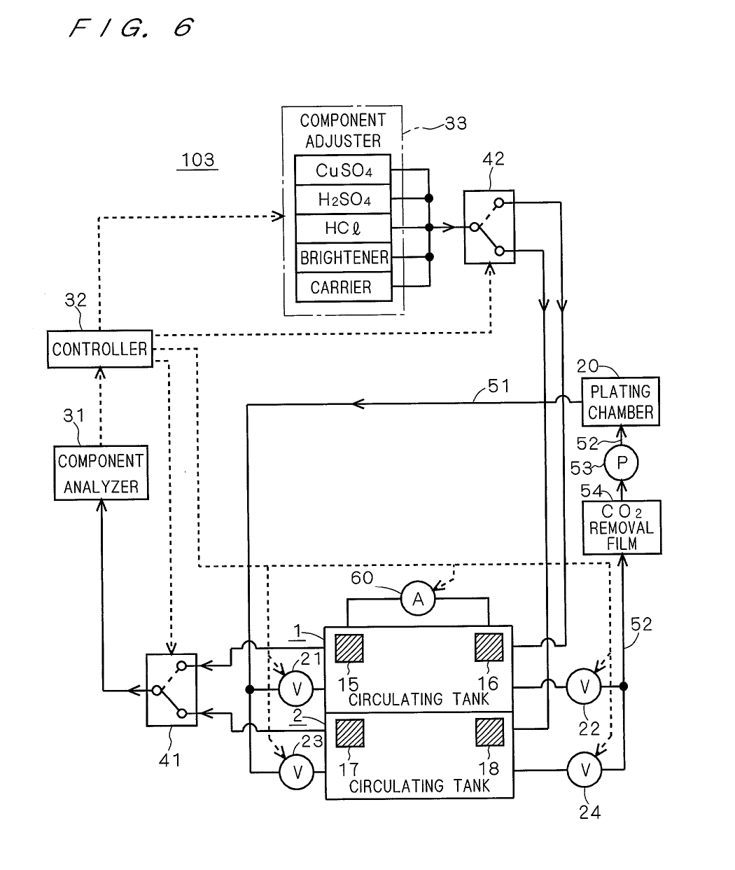

FIG. 6 is a block diagram illustrating the construction of a plating apparatus according to a third preferred embodiment. This plating apparatus 103 is characteristically different from the apparatus 101 in that the TOCUV lamp 11 is replaced with a pair of electrodes 15 and 18 for electrically decomposing a plating solution, and that the TOCUV lamp 12 is replaced with a similar pair of electrodes 17 and 18. There is added a power supply 60 for supplying current to electrodes 15 to 18. The controller 32 controls the power supply 60, instead of the TOCUV lamps 11 and 12 (FIG. 1). As material of the electrodes 14 to 16, there can be used an electrochemically rare metal such as platinum and iridium oxide.

Supplying current to the paired electrodes 15 and 16 or electrodes 17 and 18 can electrolyze the plating solution. During this process, inhibitor decomposes on the surfaces of the electrodes. That is, the electrodes 15 to 18 have the same function as the TOCUV lamps 11 and 12 of the apparatus 101 (FIG. 1).

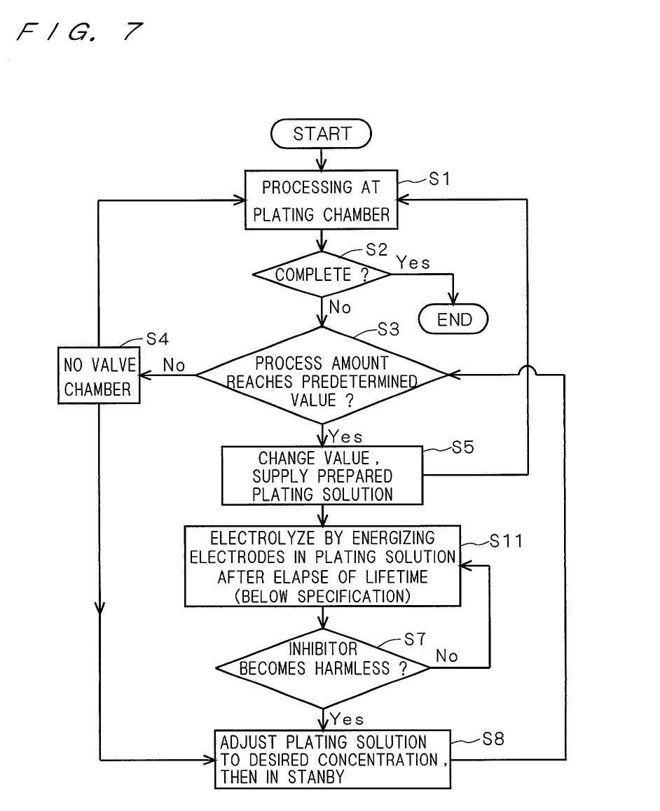

FIG. 7 is a flowchart illustrating the procedure of a plating method for subjecting a semiconductor substrate to plating processing using the apparatus 103. This method is characteristically different from the method of FIG. 2, in that step S6 is replaced with step S11. Specifically, through steps S11 and S7, current is supplied to the paired electrodes 15 and 16 (or 17 and 18) until the inhibitor contained in the plating solution held in the circulating tank 1 (or 2) in suspension is brought into harmless.

Returning to FIG. 6, of the paired electrodes 15 and 16 (or 17 and 18), at least the main component of the electrode serving as anode is preferably copper, which is the same as the main component of material to be plated. In this case, electrode reactions shown in the following chemical formulas occur at anode and cathode. Since the copper of the anode is changed to copper ions and dissolved in the plating solution, the concentration of the copper that is a plating material contained in the plating solution remains unchanged, which means the copper concentration can be maintained constant. Accordingly, it is unnecessary to adjust the concentration of the plating material.

Cu→Cu²⁺+2e⁻(anode)

Cu²⁺+2e⁻→Cu (cathode)

More preferably, the main component of all of the electrodes 15 to 18 is copper that is the same as the main component of material to be plated. In this case, as the anode exhausts, the cathode becomes greater by equivalent weight. Therefore, repetitive switching of the current polarity between the paired electrodes 15 and 16 (or 17 and 18), or alternative electrode exchange between the paired electrodes 15 and 16 (or 17 and 18), allows for semipermanent use of the electrodes 15 to 18. For the purpose of this, it is desirable that a switching mechanism for reversing polarity is incorporated into the power supply 60. The controller 32 also controls this switching mechanism.

Fourth Preferred Embodiment

FIG. 8 is a block diagram illustrating the construction of a plating apparatus according to a fourth preferred embodiment. This plating apparatus 104 is characteristically different from the apparatus 101 (FIG. 1) in that the circulating tank 2 is replaced with a buffer tank 4. The buffer tank 4 is communicated to the circulating tank 1 through piping 73 and 74, such that a plating solution can circulate between the buffer tank 4 and the circulating tank 1. A pump 75 for circulating the plating solution is interposed at any location on a circulating path of the plating solution circulating between the circulating tank 1 and the buffer tank 4. In the example of FIG. 8, the pump 75 is interposed on the piping 74. TOCUV lamp 14 is disposed in the buffer tank 4, whereas the TOCUV lamp for the circulating tank I may be omitted. A component adjuster 33 for replenishing the components of the plating solution is communicated to any location on the circulating path through which the plating solution circulates between the circulating tank 1 and buffer tank 4. In FIG. 8, the component adjuster 33 is communicated to the piping 74.

Although FIG. 8 illustrates the case of omitting a component analyzer 31 and controller 32, these may be included. The component analyzer 31 may be communicated to the buffer tank 4 so as to analyze the components of the plating solution in the buffer tank 4. The controller 32 may be arranged to control the TOCUV lamp 14 and component adjuster 33, based on the result of analysis of the component analyzer 31.

In the apparatus 104, the buffer tank 4 can be placed in the exterior of a clean area 70 (e.g., a sub-clean area), or at the underside of a floor 71 (e.g., the lower stage) of the clean area 70, as shown in FIG. 8. This leads to the advantage of reducing the area of the clean area 70 that is high in maintenance cost.

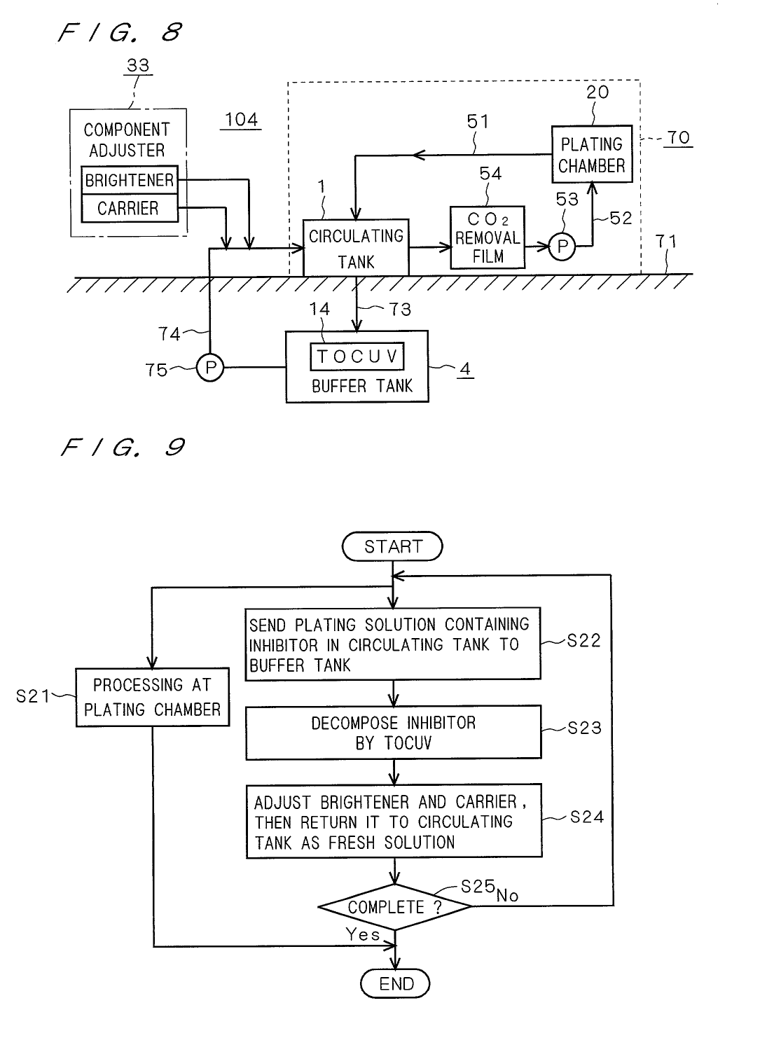

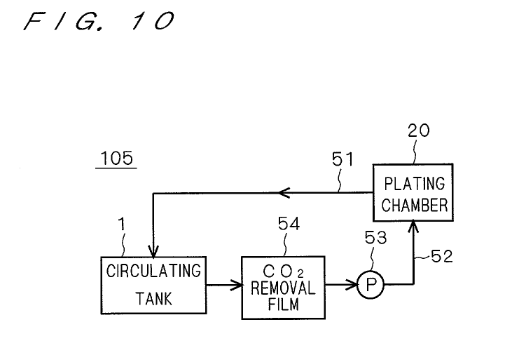

FIG. 9 is a flowchart illustrating the procedure of a plating method for subjecting a semiconductor substrate to plating processing using the apparatus 104. Before starting the processing, a plating solution is prepared, and two circulating paths of the plating solution, namely the plating chamber 20, piping 51 and 52, circulating tanks 1, piping 73 and 74, and the buffer tank 4, are arranged to be filled with the prepared plating solution.

Upon completion of this procedure, a pump 53 is operated to perform plating processing of a semiconductor substrate at the plating chamber 20 (step S21). In parallel with step S21, the following steps S22 to S24 are carried out. Steps S22 to S24 are also performed in parallel with each other. In step S22, the pump 74 is operated so that the plating solution is circulated between the circulating tank 1 and the buffer tank 4. In step S23, the TOCUV lamp 14 lights up to make inhibitor in the plating solution harmless. In step S24, the components of the plating solution is supplied to the plating solution circulating between the circulating tank 1 and buffer tank 4. A sequence of steps S21 to S24 is repeated until the time of termination (step S25).

With the foregoing procedure, the plating solution in which the inhibitor concentration is reduced to a low value and the respective concentrations of the components are adjusted in a proper permissible range, is always supplied to the plating chamber 20. Accordingly, a continuous plating processing can be executed using a plating solution properly adjusted, without dumping the plating solution. In place of the TOCUV lamp 14, the electrodes 15 and 16 can be used as in the apparatus 103 (FIG. 6).

Fifth Preferred Embodiment

FIG. 10 is a block diagram illustrating the construction of a plating apparatus according to a fifth preferred embodiment. As is the case with the plating apparatus 105, the following embodiment is practicable. Specifically, any organic matter decomposing means (e.g., TOCUV) and a component adjuster 33 are not disposed but only a carbon dioxide removal film 54 is interposed on a circulating path through which a plating solution circulates between a circulating tank 1 and plating chamber 20. Even in the absence of an organic matter decomposing means, carbon dioxide occurs as plating processing proceeds at the plating chamber 20. By continuously removing the carbon dioxide, poor plating derived from carbon dioxide can be suppressed without interruption of plating processing and replacement of the plating solution.

While the invention has been shown and described in detail, the foregoing description is in all aspects illustrative and not restrictive. It is therefore understood that numerous modifications and variations can be devised without departing from the scope of the invention.

What is claimed is:

1. A plating apparatus comprising:
a plating chamber configured to hold a plating solution and performing plating processing of a processing object to be immersed in said plating solution;
plural circulating tanks, each having an organic matter decomposing unit configured to decompose organic matter contained in said plating solution;
a first valve freely selecting one of said plural circulating tanks to provide communication between the selected one and said plating chamber such that said plating solution can circulate therebetween; and
a pump to circulate said plating solution between said selected one of said plural circulating tanks and said plating chamber.

2. The plating apparatus according to claim 1 further comprising:
a component adjuster to replenish components of said plating solution; and
a second valve freely selecting one of said plural circulating tanks to provide communication between the selected one and said component adjuster.

3. The plating apparatus according to claim 2 further comprising:
a component analyzer to analyze components of said plating solution; and
a third valve freely selecting one of said plural circulating tanks to provide communication between the selected one and said component analyzer.

4. The plating apparatus according to claim 3 further comprising:
a controller to control said first, second and third valves, said organic matter decomposing unit and said component adjuster,
said controller having the following functions of:
(i) successively switching said first valve so as to select one of said plural circulating tanks every time said plating processing reaches a predetermined amount;
(ii) with respect to the other of said plural circulating tanks, activating said organic matter decomposing means until the result of analysis of said component analyzer shows that the concentration of said organic matter reaches a permissible range; and
(iii) with respect to the other of said plural circulating tanks, activating said component adjuster until the result of analysis of said component analyzer shows that the concentrations of components of said plating solution reach a permissible range.

5. A plating apparatus comprising:
a plating chamber to hold a plating solution and to perform plating processing of a processing object to be immersed in said plating solution;
two circulating tanks, one of which has an organic matter decomposing unit configured to decompose organic matter contained in said plating solution, each of said two circulating tanks being communicated to said plating chamber so as to circulate said plating solution between each tank and said plating chamber; and
a pump to circulate said plating solution between said two circulating tanks and said plating chamber.

6. The plating apparatus according to claim 5 further comprising:
a component adjuster to replenish said plating solution in circulation with components of said plating solution.

7. The plating apparatus according to claim 6 further comprising:
a component analyzer to analyze components of said plating solution in circulation.

8. The plating apparatus according to claim 7 further comprising:
a controller to control said organic matter decomposing unit and said component adjuster,
said controller to control said component adjuster such that the result of analysis of said component analyzer shows that the concentrations of components of said plating solution are in a permissible range.

9. The plating apparatus according to claim 5, further comprising:
a controller to control said organic matter decomposing unit,
said controller activating said organic matter decomposing unit only when said plating chamber performs said plating processing of said processing object.

10. A plating apparatus comprising:
a plating chamber to hold a plating solution and perform plating processing of a processing object to be immersed in said plating solution;
a circulating tank communicated to said plating chamber so as to circulate said plating solution between said circulating tank and said plating chamber;
a buffer tank having an organic matter decomposing unit configured to decompose organic matter contained in said plating solution, said buffer tank being communicated to said circulating tank so as to circulate said plating solution between said buffer tank and said circulating tank;
a first pump to circulate said plating solution between said circulating tank and said plating chamber; and
a second pump to circulate said plating solution between said buffer tank and said circulating tank.

11. The plating apparatus according to claim 10 further comprising:
a component adjuster to replenish said plating solution circulating between said buffer tank and said circulating tank with components of said plating solution.

12. The plating apparatus according to claim 1 wherein
said organic matter decomposing unit has an ultraviolet lamp generating ultraviolet.

13. The plating apparatus according to claim 1 wherein
said organic matter decomposing unit has a pair of electrodes electrolyzing said plating solution.

14. The plating apparatus according to claim 13 wherein
a main component of at least one of said paired electrodes is the same as a main component of material to be plated to said processing object.

15. The plating apparatus according to claim 14 wherein
a main component of each of said paired electrodes is the same as a main component of material to be plated to said processing object.

16. The plating apparatus according to claim 15 further comprising:
a current supply unit configured to supply said paired electrodes with current of which polarity is changeable.

17. The plating apparatus according to claim 1, further comprising:
a carbon dioxide removal film to remove carbon dioxide from said plating solution, said carbon dioxide removal film being interposed on a circulating path of said plating solution.
